(19) United States
(12) Patent Application Publication
(10) Pub. No.: US 2026/0214110 A1
(43) Pub. Date: Jul. 23, 2026

(54) SYSTEMS AND METHODS FOR ANOMY DETECTION IN HYBRID INFRASTRUCTURE DEPLOYMENT ENVIRONMENTS

(71) Applicant: BANK OF AMERICA CORPORATION, Charlotte, NC (US)

(72) Inventors: Amer Ali, Jersey City, NJ (US); Brian Christman, Stephenville, TX (US); Saleem Gaziani, Plano, TX (US); Aaron Gee, Palm Coast, FL (US); Aisha Jenkins, Atlanta, GA (US); John Lozes, Wilmington, DE (US); Tonya Kyra Miller, Charlotte, NC (US); Manonmani Palanichamy, Fort Mill, SC (US); Jyothishwar Reddy Sama, Fort Mill, SC (US); Aravind Singtalur, McKinney, TX (US); Asha Thekkumpurath, Frisco, TX (US); Andrea M. Weisberger, Jacksonville, FL (US)

(73) Assignee: BANK OF AMERICA CORPORATION, Charlotte, NC (US)

(21) Appl. No.: 19/032,787

(22) Filed: Jan. 21, 2025

(51) Int. Cl. H04L 9/40; H04L 41/16

(52) U.S. Cl. CPC H04L 63/1425; H04L 41/16

(57) ABSTRACT

Systems, computer program products, and methods are described herein for anomaly detection in hybrid infrastructure deployment environments. The present disclosure is configured to receive and extract code deployment metadata from one or more code repositories and execute a code deployment security protocol on the code deployment metadata. In addition, the present disclosure is configured to transmit the code deployment metadata to a distributed computing environment, wherein the distributed computing environment comprises one or more application platforms. In addition, the present disclosure is configured to receive network data packets from the one or more application platforms via a network gateway. An AI engine determines network anomalies based on the network data packets. The present disclosure also is configured to generate and transmit a notification based on the network anomalies.

### TECHNOLOGICAL FIELD

Example embodiments of the present disclosure relate to anomaly detection in hybrid infrastructure deployment environments.

### BACKGROUND

Managing electronic environment infrastructure for secure, efficient, and effective application integration and application programming interface (API) management is challenging due to data security, cybersecurity, and performance criteria. For example, centralized infrastructure environments may provide enhanced protection of sensitive data, but electronic environment maintenance, security patching, and threat monitoring consumes technical resources and comprises technical complexity. While distributed network-based, cloud-hosted electronic environments simplify burdens associated with equipment maintenance and security updates, this infrastructure framework vastly increases security challenges with confidential and sensitive information. For example, hosting sensitive data, code, and configurations in the cloud increases exposure to threat actors, introduces complex challenges with data security, and limits control of the electronic environment.

Hybrid infrastructure frameworks can alleviate challenges with continuous infrastructure maintenance in on-premises hosted electronic environments, while maintaining additional control of sensitive data. However, utilizing a hybrid infrastructure framework, involving centralized computing and cloud computing, creates challenges with anomaly detection, security requirement adherence, and evaluating network traffic transmitted between on-premises infrastructure and the cloud. As hybrid infrastructure deployments increase in utilization, it is essential to develop methods for effective cross-environment network traffic monitoring and anomaly detection to increase security, streamline infrastructure maintenance, and protect sensitive data, API configurations, and code deployment packages.

Applicant has identified a number of deficiencies and problems associated with anomaly detection in hybrid infrastructure deployment environments. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for anomaly detection in hybrid infrastructure deployment environments.

In one aspect, a system for anomaly detection in hybrid infrastructure deployment environments is provided. In some embodiments, the system may comprise: a memory device with computer-readable program code stored thereon; at least one processing device, wherein executing the computer-readable program code is configured to cause the at least one processing device to execute the computer-readable program code to: receive and extract code deployment metadata from one or more code repositories; execute a code deployment security protocol on the code deployment metadata; transmit the code deployment metadata to a distributed computing environment, wherein the distributed computing environment comprises one or more application platforms; receive network data packets from the one or more application platforms via a network gateway; determine, using an artificial intelligence (AI) engine, network anomalies based on the network data packets; and generate and transmit a notification based on the network anomalies.

In some embodiments, executing the computer-readable program code is further configured to cause the at least one processing device to: segment, via the AI engine, the network anomalies for a threat remediation protocol; execute a network data packet security protocol on the network data packets, wherein the network data packet security protocol comprises decrypting the network data packets and validating code signing of the network data packets; transmit the network data packets to a runtime engine; and execute, via the runtime engine, a code package based on at least the network data packets.

In some embodiments, executing the computer-readable program code is further configured to cause the at least one processing device to: generate, using the AI engine, a communication channel to one or more network devices, wherein the AI engine comprises a generative AI model; authenticate the one or more network devices; monitor, via the AI engine, network traffic data based on one or more internal networks; identify, via the AI engine, one or more additional network anomalies based on at least the network traffic data; generate, using the AI engine, network anomaly remediations based on the network anomalies and the one or more additional network anomalies; generate and transmit a remediation notification, via the communication channel, comprising the network anomaly remediations; receive control signals from the one or more network devices, wherein the control signals comprise determined network anomaly remediations; and execute, via the AI engine, the determined network anomaly remediations.

In some embodiments, executing the computer-readable program code is further configured to cause the at least one processing device to: generate a user interface; render one or more interactive interface elements within the user interface; receive interface control signals; modify the one or more interactive interface elements based on at least the interface control signals, wherein the interface control signals comprise at least one of authentication criteria, network traffic criteria, and security criteria; and revise at least one of the AI engine, the network gateway, the network anomaly remediations, the code deployment security protocol, the network data packet security protocol, the distributed computing environment, the runtime engine, the one or more application platforms, one or more firewalls, and one or more electronic environments based on at least the interface control signals.

In some embodiments, the code deployment security protocol further comprises code signing the code deployment metadata and encrypting the code deployment metadata.

In another aspect, a computer program product for anomaly detection in hybrid infrastructure deployment environments is provided.

In some embodiments, executing the computer-readable program code is further configured to cause the at least one processing device to: receive at least one historical dataset; train the AI engine based on the at least one historical dataset; receive network packet anomaly data; update the at least one historical dataset with the network packet anomaly data; and retrain the AI engine based on the network packet anomaly data.

In some embodiments, executing the computer-readable program code is further configured to cause the at least one processing device to: determine, via the AI engine, a failure of the code deployment security protocol; and generate and transmit an alert comprising the failure of the code deployment security protocol.

In some embodiments, executing the computer-readable program code is further configured to cause the at least one processing device to: identify, using the AI engine, a security threshold associated with the code deployment metadata; determine, using the AI engine, that the security threshold exceeds a predetermined network security threshold; intercept, using the AI engine, the code deployment metadata from transmission to the distributed computing environment; and transmit an interception alert via notification.

In some embodiments, executing the computer-readable program code is further configured to cause the at least one processing device to: generate a network linkage between the one or more application platforms and an electronic runtime environment, wherein the one or more application platforms further comprises an application programming interface (API) console; implement, via the AI engine, rules criteria for network transmissions between the one or more application platforms and the electronic runtime environment; monitor, via the AI engine, network transmissions to determine network transmission anomalies; generate, via the AI engine, one or more dashboards; and revise dynamically the one or more dashboards based on the network transmissions.

In some embodiments, executing the computer-readable program code is further configured to cause the at least one processing device to: receive a network anomaly simulation request, wherein the network anomaly simulation request comprises revised network data; authenticate the network anomaly simulation request via multifactor authentication, wherein the multifactor authentication comprises at least two of a one-time password, a physical attribute authentication, authentication application, and authentication credentials; revise at least one of the code deployment metadata, code deployment security protocol, and network anomalies based on the network anomaly simulation request; generate, using the AI engine, revised network anomaly remediations; and transmit the revised network anomaly remediations.

In another aspect, a computer program product for anomaly detection in hybrid infrastructure deployment environments is provided. In some embodiments, the computer program product comprises at least one non-transitory computer-readable medium having computer-readable program code portion embodied therein, the computer-readable program code portions which when executed by a processing device are configured to cause a processor to: receive and extract code deployment metadata from one or more code repositories; execute a code deployment security protocol on the code deployment metadata; transmit the code deployment metadata to a distributed computing environment, wherein the distributed computing environment comprises one or more application platforms; receive network data packets from the one or more application platforms via a network gateway; determine, using an AI engine, network anomalies based on the network data packets; and generate and transmit a notification based on the network anomalies.

In some embodiments, the processing device is further configured to: segment, via the AI engine, the network anomalies for a threat remediation protocol; execute a network data packet security protocol on the network data packets, wherein the network data packet security protocol comprises decrypting the network data packets and validating code signing of the network data packets; transmit the network data packets to a runtime engine; and execute, via the runtime engine, a code package based on at least the network data packets.

In some embodiments, the processing device is further configured to: generate, using the AI engine, a communication channel to one or more network devices, wherein the AI engine comprises a generative AI model; authenticate the one or more network devices; monitor, via the AI engine, network traffic data based on one or more internal networks; identify, via the AI engine, one or more additional network anomalies based on at least the network traffic data; generate, using the AI engine, network anomaly remediations based on the network anomalies and the one or more additional network anomalies; generate and transmit a remediation notification, via the communication channel, comprising the network anomaly remediations; receive control signals from the one or more network devices, wherein the control signals comprise determined network anomaly remediations; and execute, via the AI engine, the determined network anomaly remediations.

In some embodiments, the processing device is further configured to: generate a user interface; render one or more interactive interface elements within the user interface; receive interface control signals; modify the one or more interactive interface elements based on at least the interface control signals, wherein the interface control signals comprise at least one of authentication criteria, network traffic criteria, and security criteria; and revise at least one of the AI engine, the network gateway, the network anomaly remediations, the code deployment security protocol, the network data packet security protocol, the distributed computing environment, the runtime engine, the one or more application platforms, one or more firewalls, and one or more electronic environments based on at least the interface control signals.

In some embodiments, the code deployment security protocol further comprises code signing the code deployment metadata and encrypting the code deployment metadata.

In some embodiments, the processing device is further configured to: receive at least one historical dataset; train the AI engine based on the at least one historical dataset; receive network packet anomaly data; update the at least one historical dataset with the network packet anomaly data; and retrain the AI engine based on the network packet anomaly data.

In some embodiments, the processing device is further configured to: determine, via the AI engine, a failure of the code deployment security protocol; and generate and transmit an alert comprising the failure of the code deployment security protocol.

In another aspect, a computer-implemented method for anomaly detection in hybrid infrastructure deployment environments is provided. In some embodiments, the computer-implemented method comprising: receiving and extracting code deployment metadata from one or more code repositories; executing a code deployment security protocol on the code deployment metadata; transmitting the code deployment metadata to a distributed computing environment, wherein the distributed computing environment comprises one or more application platforms; receiving network data packets from the one or more application platforms via a network gateway; determining, using an AI engine, network anomalies based on the network data packets; and generating and transmitting a notification based on the network anomalies.

In some embodiments, the computer-implemented method is further configured for: segmenting, via the AI engine, the network anomalies for a threat remediation protocol; executing a network data packet security protocol on the network data packets, wherein the network data packet security protocol comprises decrypting the network data packets and validating code signing of the network data packets; transmitting the network data packets to a runtime engine; and executing, via the runtime engine, a code package based on at least the network data packets.

In some embodiments, the computer-implemented method is further configured for: generating, using the AI engine, a communication channel to one or more network devices, wherein the AI engine comprises a generative AI model; authenticate the one or more network devices; monitor, via the AI engine, network traffic data based on one or more internal networks; identifying, via the AI engine, one or more additional network anomalies based on at least the network traffic data; generating, using the AI engine, network anomaly remediations based on the network anomalies and the one or more additional network anomalies; generating and transmitting a remediation notification, via the communication channel, comprising the network anomaly remediations; receiving control signals from the one or more network devices, wherein the control signals comprise determined network anomaly remediations; and executing, via the AI engine, the determined network anomaly remediations.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for anomaly detection in hybrid infrastructure deployment environments, in accordance with an embodiment of the disclosure;

FIG. 2 illustrates an exemplary AI engine subsystem architecture, in accordance with an embodiment of the disclosure;

FIG. 3 illustrates an exemplary generative AI engine subsystem architecture, in accordance with an embodiment of the disclosure;

FIG. 4 illustrates a process flow 400 for anomaly detection in hybrid infrastructure deployment environments, in accordance with an embodiment of the disclosure;

FIG. 5 illustrates a process flow 500 for validating network data packets and executing a code package, in accordance with an embodiment of the disclosure;

FIG. 6 illustrates a process flow 600 for identifying network anomalies and generating network anomaly remediations, in accordance with an embodiment of the disclosure;

FIG. 7 illustrates a process flow 700 for modifying requirements for authentication, network traffic, and security, in accordance with an embodiment of the disclosure;

FIG. 8 illustrates a process flow 800 for training and retraining the AI engine, in accordance with an embodiment of the disclosure;

FIG. 9 illustrates a process flow 900 for generating an alert based on the code deployment security protocol, in accordance with an embodiment of the disclosure;

FIG. 10 illustrates a process flow 1000 for intercepting, using the AI engine, the code deployment metadata from transmission, in accordance with an embodiment of the disclosure;

FIG. 11 illustrates a process flow 1100 for generating a network linkage and one or more dashboards, via the AI engine, and revising the one or more dashboards, in accordance with an embodiment of the disclosure; and

FIG. 12 illustrates a process flow 1200 for generating revised network anomaly remediations, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, a network, a network device, a router, a switch, a processor, a network gateway, an enterprise service, a software service, an electronic environment, or any combination thereof. When discussing that resource transfers or transactions are evaluated, it could mean that the transaction has already occurred, is in the process of occurring or being processed, or that the transaction has yet to be processed/posted by one or more users, merchants, entities, networks, network devices, routers, switches, processors, network gateways, enterprise services, software services, electronic environments, or any combination thereof. In some embodiments, a resource transfer or transaction may refer to non-financial activities of the user. In this regard, the transaction may be a customer account event, such as but not limited to the customer changing a password, adding new accounts, opening new accounts, adding or modifying account parameters/restrictions, performing/modifying authentication procedures and/or credentials, and the like.

As described in further detail, the present disclosure provides a solution to the above-referenced problems in the by field of technology by providing anomaly detection in hybrid infrastructure deployment environments. The system utilizes an AI engine that continuously monitors and analyzes communications, network traffic, and network transmissions between one or more on-premises electronic environments and one or more cloud-hosted electronic environments to detect anomalies, identify unusual network traffic patterns, execute behavioral analysis, and generate real-time alerts for remediation responsive actions. The system may receive and extract code deployment data, from one or more code repositories, and execute a code deployment security protocol on the code deployment metadata. The code deployment security protocol may ensure secure transfer of metadata between the electronic environments and may minimize the volume of metadata for certain network transmissions by executing code signing and encryption to preserve data integrity. In addition, the system validates and verifies metadata prior to inclusion in a network transmission to the cloud-hosted environment.

Accordingly, the present disclosure provides anomaly detection in hybrid infrastructure deployment environments. For instance, utilizing an entirely on-premises infrastructure deployment framework can minimize transmitting sensitive code and confidential data to external actors, environments, and application platforms. However, executing periodic maintenance for on-premises environments, including without limitation security patches, version upgrades, and equipment changes, requires extensive technical resources, technical knowledge, large lead times, and investment. While cloud computing may provide enhanced infrastructure scalability, reduced maintenance costs, and dynamic analytics capabilities compared to on-premises computing, hosting sensitive code and configuration data in a public cloud poses security threats and challenges in detecting vulnerabilities. Hybrid infrastructure deployment environments typically require transmitting code and configurations (i.e., API configurations, application configurations, etc.) between the on-premises environment and the cloud environment, which creates vulnerabilities and increases the difficulty in detecting and remediating such vulnerabilities and/or anomalies. Furthermore, network transmissions and network communications (e.g., one-way and/or two-way) between on-premises systems, devices, and/or agents and cloud-hosted management consoles are subject to various attacks, including without limitation Denial of Service (DDoS), Structured Query Language (SQL) injections, Trojan malware, non-Trojan malware, ransomware, spyware, and/or other security issues. In such hybrid infrastructure deployment environments, anomaly and vulnerability detection and mitigation is challenging, complex, slow, and lack automatic, intelligent anomaly detection.

What is more, the present disclosure provides a technical solution to a technical problem. As described herein, the technical problem includes anomaly detection in hybrid infrastructure deployment environments. The technical solution presented herein allows for dynamic, intelligent, and end-to-end network monitoring, network anomaly detection, and AI-generated remediations. In particular, anomaly detection in hybrid infrastructure deployment environments is an improvement over existing solutions to the technical challenges, (i) with fewer steps to achieve the solution, thus reducing the amount of computing resources, such as processing resources, storage resources, network resources, and/or the like, that are being used (e.g., utilizing on-premises runtime agent and cloud-hosted management console, an AI engine for efficient network monitoring and anomaly detection in network transmissions, and/or the like), (ii) providing a more accurate solution to problem, thus reducing the number of resources required to remedy any errors made due to a less accurate solution (e.g., using code signing and encryption to protect sensitive data prior to transmitting to an external cloud environment, utilizing an API gateway to apply security rules, utilizing an AI engine for anomaly detection and/or leveraging decryption and code signing validation to validate data transmitted from the cloud to the on-premises environment), (iii) removing manual input and waste from the implementation of the solution, thus improving speed and efficiency of the process and conserving computing resources (e.g., by utilizing an AI engine for anomaly detection and generating anomaly remediation recommendations and mitigating responsive actions), (iv) determining an optimal amount of resources that need to be used to implement the solution, thus reducing network traffic and load on existing computing resources (e.g., by utilizing an on-premises runtime agent and a cloud-hosted management console for managing APIs and executing analytics). Furthermore, the technical solution described herein uses a rigorous, computerized process to perform specific tasks and/or activities that were not previously performed. In specific implementations, the technical solution bypasses a series of steps previously implemented, thus further conserving computing resources.

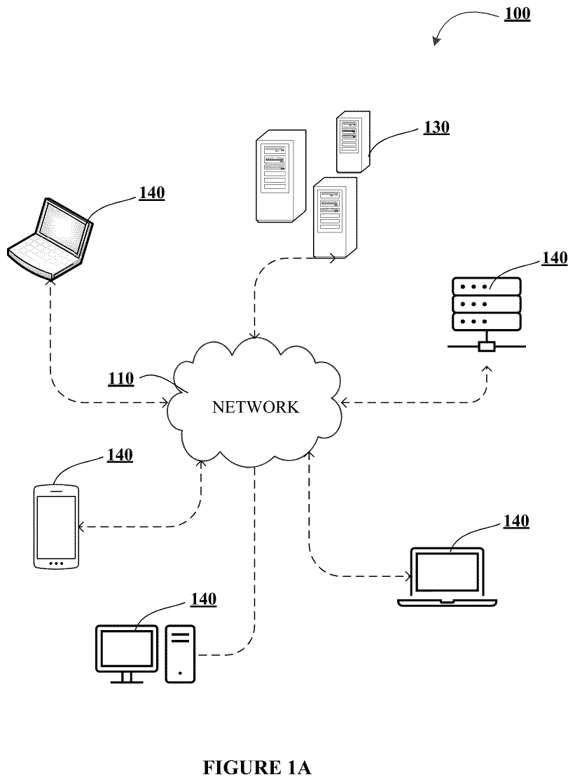

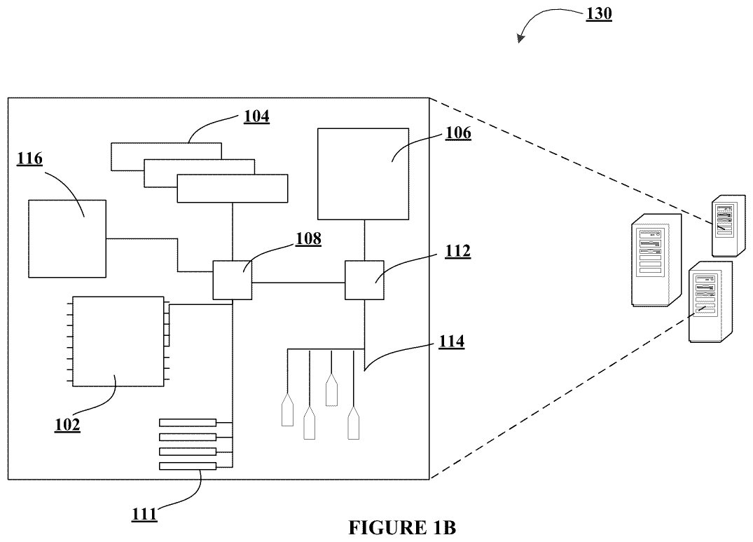

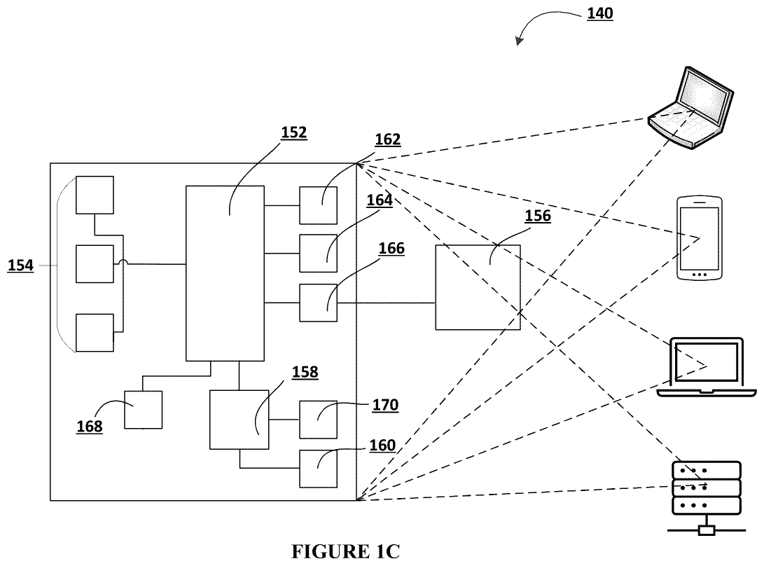

FIGS. 1A-1C illustrate technical components of an exemplary distributed computing environment for anomaly detection in hybrid infrastructure deployment environments 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

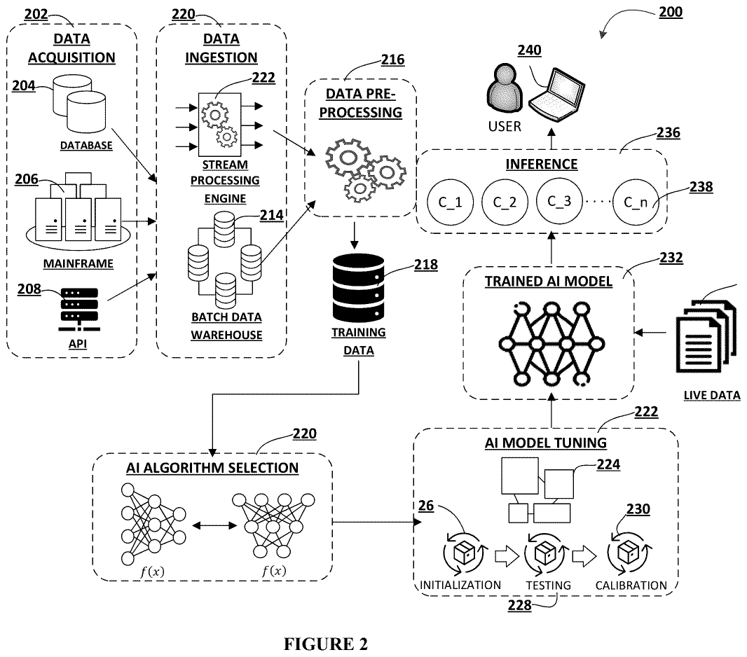

FIG. 2 illustrates an exemplary AI engine subsystem architecture 200, in accordance with an embodiment of the disclosure. The artificial intelligence subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including Rational Database Management Systems (RDBMs), other types of databases, Simple Storage System (S3) buckets, Comma Separated Values (CSVs), or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the Machine Learning (ML) model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

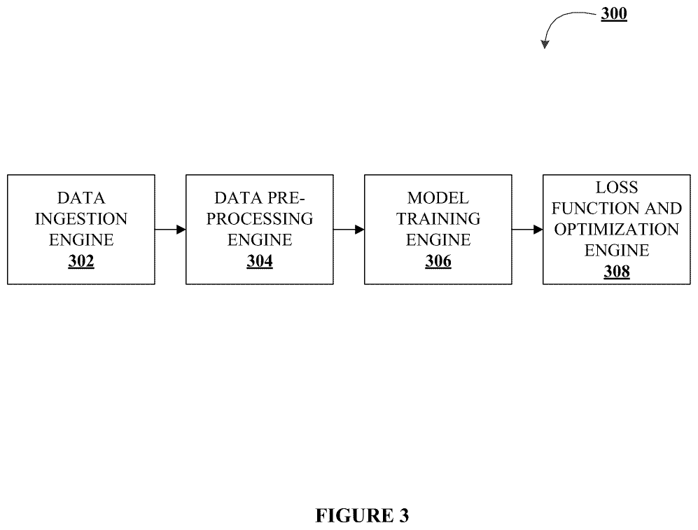

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a Large Language Model (LLM), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In Machine Learning (ML), the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, Bidirectional Encoder Representations from Transformers (BERT), Generative Pre-trained Transformer (GPT), or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to manage tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or Recurrent Neural Networks (RNNs) like WaveNet, designed to manage sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL (Kullback-Liebler) divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or Graphical Processing Units (GPUs), where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

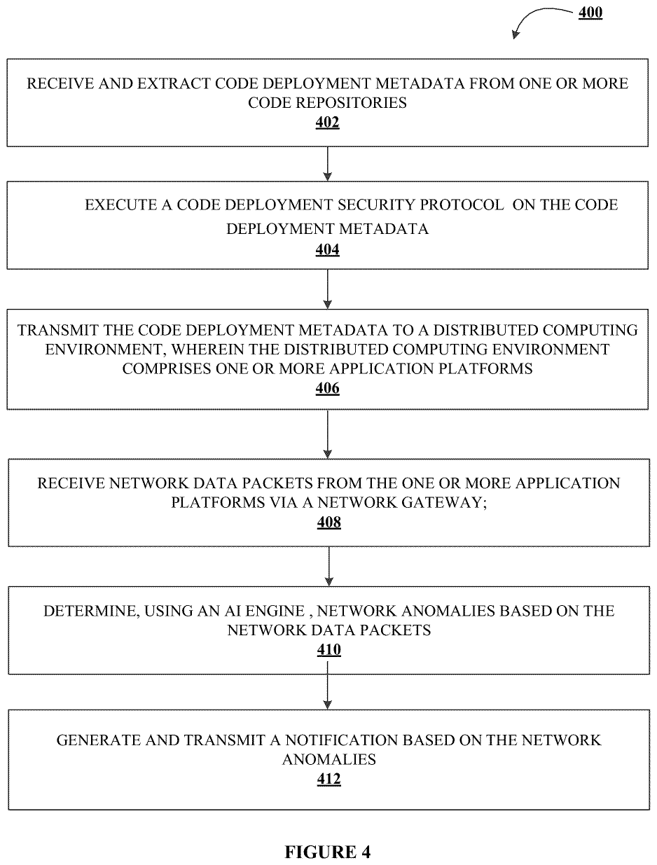

FIG. 4 illustrates a process flow 400 for anomaly detection in hybrid infrastructure deployment environments, in accordance with an embodiment of the disclosure. In some embodiments, a system (e.g., similar to one or more of the systems described herein with respect to FIGS. 1A-1C) may perform one or more of the steps of process flow 400. For example, an anomaly detection in hybrid infrastructure deployment environments system (e.g., the system 130 described herein with respect to FIGS. 1A-1C) may perform the steps of process flow 400. In some embodiments, an AI engine (e.g., such as the AI engine like that described in FIG. 2) or a generative AI subsystem (e.g., such as the generative AI subsystem described in FIG. 3) may perform some or all of the steps described in process flow 400.

As shown in block 402 the process flow 400 may include the step of receiving and extracting code deployment metadata from one or more code repositories. In some embodiments, the code deployment metadata may be transmitted via a communication channel, wherein the communication channel comprises encrypted transmissions, communications, data pipelines, and/or the like. According to some embodiments, the transmission of code deployment metadata may be determined by determined API policies comprising criteria for secure communications between at least two electronic environments (e.g., at least one cloud-hosted console and at least one on-premises runtime environment). The API policies may comprise authentication, authorization, network traffic controls, and security criteria. In some embodiments, the code deployment metadata may be transmitted across at least one electronic environment, network (e.g., internal network, external network, and/or the like), and/or the like. In some embodiments, the system may use an Extract, Transform, and Load (ETL) process to receive the code deployment metadata from the at least one or more data sources, process the extracted code deployment metadata, and then store the extracted code deployment metadata in an internal data storage repository.

According to some embodiments, the one or more code repositories may comprise internal data repositories (e.g., distributed version control system, continuous integration and continuous deployment platform, centralized artifact repository, relational databases, data lakes, data warehouses, and/or distributed ledger frameworks) and/or external data repositories (e.g., relational databases, data lakes, data warehouses, and/or distributed ledger frameworks). The one or more code repositories may comprise one or more network device accounts and/or API consoles, according to some embodiments, which may be associated with one or more users, network devices, applications, software-as-a-service modules, entities, decentralized autonomous organizations, and/or the like.

In some embodiments, the code deployment metadata may comprise artifacts, packages, artifact repository uniform resource locators, executables, source code, license data, version number, functionality descriptions, creation date, modification date, author, most recent author, dependencies, and/or the like. According to some embodiments, the artifacts may comprise data objects, images, docker images, modules, containers, libraries, caches, and/or the like.

As shown in block 404, the process flow 400 may include the step of executing a code deployment security protocol on the code deployment metadata. In some embodiments, the code deployment security protocol may comprise a code signing process, wherein a digital signature is applied to an artifact, software file, executables, scripts, and/or the like. The code signing process may comprise processing software to create a digital fingerprint associated with the content of the software via hashing, according to some embodiments. The digital signature may be generated utilizing a private key to encrypt the digital fingerprint, according to some embodiments. The private key may be store in a key vault, according to some embodiments. In such configurations, and in some embodiments, a corresponding public key may be utilized to verify the digital signature. In some embodiments, the digital signature may be affixed and/or attached to the software. A trusted certificate authority may generate and issue a code signing certificate to establish trust in the code signing process, according to some embodiments. In some embodiments, the code deployment security protocol may be executed by a software service program, application, enterprise services application, and/or module. In some embodiments, the code deployment security protocol comprises encryption microservices and public key infrastructure to ensure secure authentication and authorization.

As shown in block 406, the process flow 400 may include the step of transmitting the code deployment metadata to a distributed computing environment, wherein the distributed computing environment comprises one or more application platforms. In some embodiments, the code deployment metadata may comprise blank Java Archive data enriched with encrypted metadata. In some embodiments, the code deployment metadata may be transmitted via a communication channel (e.g., shared or unique), wherein the communication channel comprises encrypted transmissions, communications, data pipelines, secure socket layer (SSL), transport layer security, APIs, and/or the like. In some embodiments, the code deployment metadata may be transmitted across at least one electronic environment, network (e.g., internal network, external network, and/or the like), and/or the like. According to some embodiments, the code deployment metadata may be transmitted as packets via a gateway firewall.

In some embodiments, the distributed computing environment may use an ETL process to receive the code deployment metadata, process the extracted code deployment metadata, and then store the extracted code deployment metadata in an external data storage repository. In some embodiments, the one or more application platforms comprises connectors, network services, storage repositories, network devices, servers, routers, switches, databases, connectors, database, API management consoles, API design and development consoles, software integration tools, and/or the like. According to some embodiments, the one or more application platforms may comprise one or more network connections to an on-premises-hosted electronic computing environment. In some embodiments, the code deployment metadata may comprise updates to an API management console, API design and development consoles, and/or downstream updates to a runtime engine.

As shown in block 408, the process flow 400 may include the step of receiving network data packets from the one or more application platforms via a network gateway. In some embodiments, the network gateway may comprise an API gateway to exchange network communications between the one or more application platforms an internal-hosted (e.g., private cloud, hybrid, and/or on-premises) electronic environment. The network gateway executes API policies to ensure secure network communications, in some embodiments. By way of non-limiting example, and in some embodiments, the network gateway may execute open authorization to exchange network communications via access tokens. In some embodiments, the network gateway may utilize JSON (JavaScript Object Notation) web tokens (JWT) (e.g., encoded JSON comprising claims and a signature) to authenticate the one or more application platforms and exchange network communications. In some embodiments, the network gateway may utilize Security Assertion Markup Language (SAML) for exchanging authentication data to authenticate the one or more application platforms and for exchanging authorized data packets between the network gateway and the one or more application platforms.

In some embodiments, the network gateway may apply security policies, such as monitoring network traffic and limiting traffic patterns to prevent DDoS attacks. According to some embodiments, the network gateway may evaluate network transmission requests from the one or more application platforms to intercept and block malicious SQL injection attempts. The network gateway may utilize signatures and heuristic analysis to inspect artifacts and data packets to detect Trojan attacks and/or malware attacks, in some embodiments.

According to some embodiments, the network gateway may apply traffic management policies, such as throttling (e.g., control network traffic flow between on-premises and cloud electronic environments), IP address restrictions (e.g., validating that only trusted IP addresses are allowed to interact with on-premises systems), and/or rate limiting (e.g., restricting the quantity of API requests from at least one determined IP address and/or application to prevent network overload). In some embodiments, the network gateway may query one or more internal repositories to retrieve trusted IP addresses, may determine IP addresses and/or applications that contain restricted API request quantities via the AI engine, and/or may utilize the AI engine to determine controls for network traffic flow.

As shown in block 410, the process flow 400 may include the step of determining, using an AI engine, network anomalies based on the network data packets. The AI engine may analyze the network data packets to determine abnormal patterns in cloud-to-on-premises network communications, according to some embodiments. In some embodiments, the AI engine may detect network anomalies associated with abnormal traffic patterns (e.g., spikes from specific IP addresses, the one or more application platforms, and/or the like) associated with malicious attacks and/or unauthorized access attempts. In some embodiments, the AI engine may comprise a machine learning algorithm to learn regular traffic behavior over time periods. By way of non-limiting example, and in some embodiments, the AI engine may detect deviations in traffic behavior, execute behavioral analyses, and determine deviations in traffic behavior that signal an intrusion by an unauthorized actor and/or a misconfiguration in infrastructure, software, software services, and/or the like (e.g., network anomalies).

As shown in block 412, the process flow 400 may include the step of generating and transmitting a notification based on the network anomalies. In some embodiments, the AI engine may generate and/or transmit the notification. According to some embodiments of the disclosure, the notification may comprise the network anomalies. In some embodiments, the notification may comprise a communication transmission, wherein the communication transmission may comprise text data, audio data, visual data, and/or the like. In some embodiments, the notification may be transmitted via an ETL process, transmitted to a network device, and/or transmitted to a user device associated with at least one network user. According to some embodiments, the AI engine may generate network anomaly remediation actions based on the network anomalies and transmit the network anomaly remediation actions via notification.

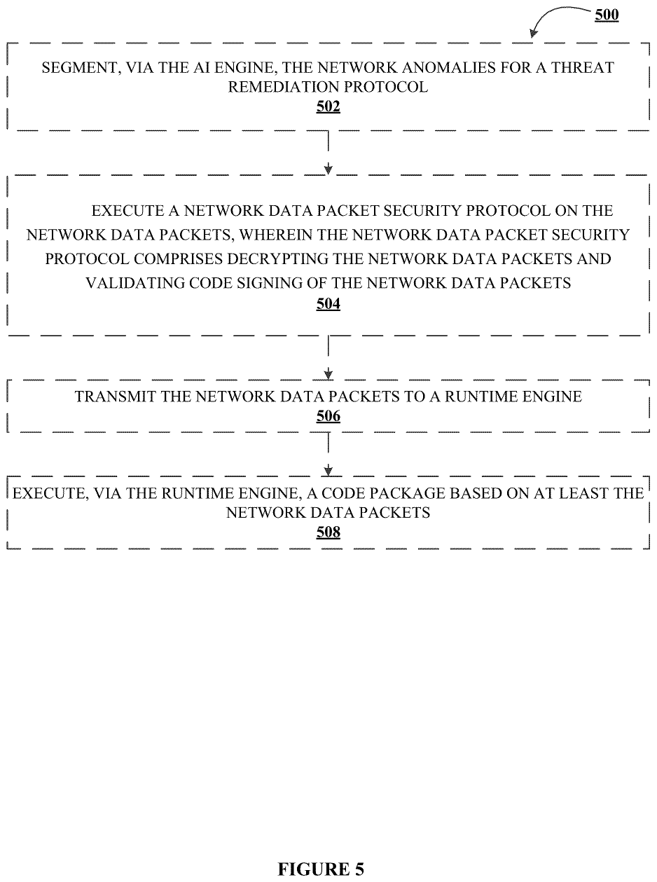

FIG. 5 illustrates a process flow 500 for validating network data packets and executing a code package. In some embodiments, a system (e.g., similar to one or more of the systems described herein with respect to FIGS. 1A-1C) may perform one or more of the steps of process flow 500. For example, an anomaly detection in hybrid infrastructure deployment environments system (e.g., the system 130 described herein with respect to FIGS. 1A-1C) may perform the steps of process flow 500. In some embodiments, an AI engine (e.g., such as the AI engine like that described in FIG. 2) or a generative AI subsystem (e.g., such as the generative AI subsystem described in FIG. 3) may perform some or all of the steps described in process flow 500.

As shown in block 502, the process flow 500 may include the step of segmenting, via the AI engine, the network anomalies for a threat remediation protocol. In some embodiments, the threat remediation protocol may comprise generating subnets to restrict network traffic flow from the one or more application platforms, IP addresses, and/or the like. According to some embodiments, the threat remediation protocol may comprise shutting down one or more network ports, shutting down the network in which the network anomalies were detected, shutting down the network gateway, redirecting traffic through a specified port and/or gateway and/or subnet. The threat remediation protocol may comprise generating remediation recommendations to mitigate network anomalies, requiring additional authentication for access, and/or the like.

As shown in block 504, the process flow 500 may include the step executing a network data packet security protocol on the network data packets, wherein the network data packet security protocol comprises decrypting the network data packets and validating code signing of the network data packets. In some embodiments, the network data packet security protocol comprises utilizing a public key to verify a digital signature of the network data packets. The AI engine may confirm the success or failure of the verification, in some embodiments. By way of non-limiting example, and in some embodiments, the AI engine may determine that the verification failed, may generate an error log, and/or may transmit an alert comprising the error log. By only permitting validated and verified data to transmit from the one or more application platforms and/or cloud environment, the system prevents unauthorized modifications and/or unauthorized access, thereby improving network security, data security, and/or application of security rules criteria to the system.

As shown in block 506, the process flow 500 may include the step of transmitting the network data packets to a runtime engine. According to some embodiments, transmitting the network data packets may comprise executing an ETL process. In some embodiments, the AI engine may transmit the network data packets. According to some embodiments, transmissions to the network data packets may occur dynamically in real-time, via batch processing at determined intervals, via trigger to initiate transmissions, and/or upon receipt of an on-demand transmission request. According to some embodiments, the network data packets may be again re-evaluated for anomalies prior to the runtime engine receiving the network data packets.

As shown in block 508, the process flow 500 may include the step executing, via the runtime engine, a code package based on at least the network data packets. In some embodiments, the runtime engine may comprise an on-premises-hosted agent that retrieves and processes deployment artifacts within the on-premises electronic environment. In executing the code packages on-premises via the runtime agent, the system ensures that sensitive data is always processed on-premises and avoids sensitive data ever transmitting to the cloud. According to some embodiments, the runtime engine may comprise a lightweight integration engine that is configured to execute applications and supports the API policies. In some embodiments, the AI engine may execute the code package based on at least the network data packets, network anomalies, and/or the like. By utilizing an on-premises runtime agent, the present invention improves the security of hybrid infrastructure deployment environments because sensitive application code and deployment artifacts never are transmitted outside the on-premises environment. Furthermore, the present invention only transmits and/or receives encrypted and signed metadata via a cloud-hosted API management console, management console, and/or console, further reducing security vulnerabilities.

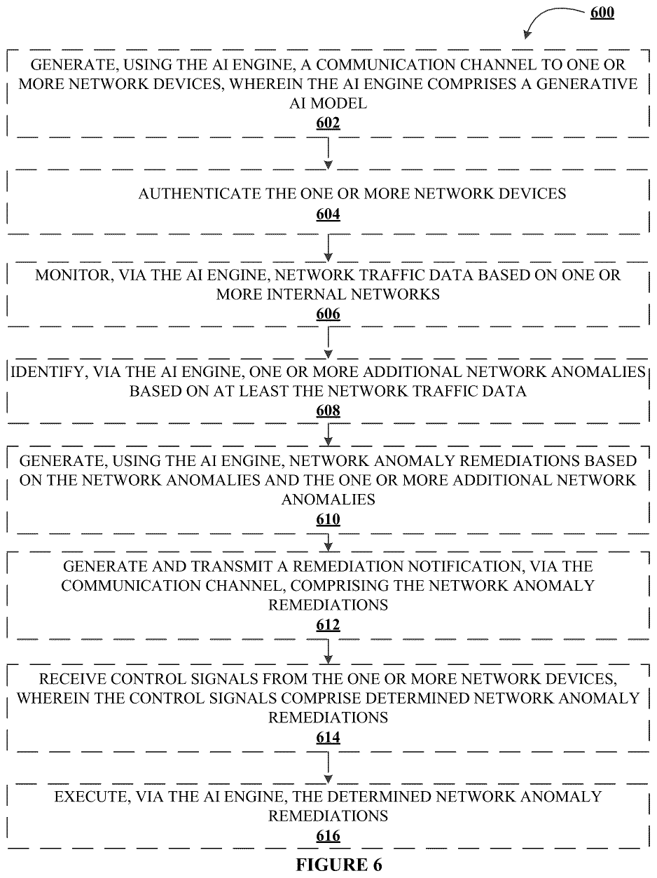

FIG. 6 illustrates a process flow 600 for identifying network anomalies and generating network anomaly remediation, in accordance with an embodiment of the disclosure. In some embodiments, a system (e.g., similar to one or more of the systems described herein with respect to FIGS. 1A-1C) may perform one or more of the steps of process flow 600. For example, an anomaly detection in hybrid infrastructure deployment environments system (e.g., the system 130 described herein with respect to FIGS. 1A-1C) may perform the steps of process flow 600. In some embodiments, an AI engine (e.g., such as the AI engine like that described in FIG. 2) or a generative AI subsystem (e.g., such as the generative AI subsystem described in FIG. 3) may perform some or all of the steps described in process flow 600.

As shown in block 602, the process flow 600 may include the step of generating, using the AI engine, a communication channel to one or more network devices, wherein the AI engine comprises a generative AI model. In some embodiments, the generative AI model may comprise an LLM, VAE, autoregressive model, RNN, transformer-based model, and/or the like. According to some embodiments, the communication channel may comprise encrypted transmissions, communications, and/or the like. The one or more network devices may comprise routers, switches, endpoints, user devices, and/or the like, according to some embodiments.

As shown in block 604, the process flow 600 may include the step of authenticating the one or more network devices. According to some embodiments, authenticating the one or more network devices may comprise at least one of authentication credentials, one-time password, physical attribute authentication, authenticator mobile application, PIN code, and/or multi-factor authentication. The system may generate and transmit an authentication request to the one or more network devices to execute an authentication protocol, according to some embodiments. Upon receiving authentication data from the one or more network devices, the system may execute the authentication protocol, wherein the authentication protocol may authenticate at least one of the one or more network devices, rejections authenticating at least one of the one or more network devices, and/or generates an error and transmits an alert via notification, according to some embodiments.

As shown in block 606, the process flow 600 may include the step of monitoring, via the AI engine, network traffic data based on one or more internal networks. In some embodiments, the AI engine may monitor network traffic, network data packets, and/or the like to detect anomalies within the on-premises environment. In some embodiments, the AI engine may monitor network traffic data transmitted from the continuous integration and continuous deployment platform to the centralized artifact repository, from the centralized artifact repository to an API deployment engine (e.g., executes the code deployment security protocol and the network data packet security protocol), from the API deployment engine to the gateway firewall, and/or the like.

As shown in block 608, the process flow 600 may include the step of identifying, via the AI engine, one or more additional network anomalies based on at least the network traffic data. In some embodiments, the AI engine may detect the one or more additional network anomalies based on the network traffic data, known network anomalies, emerging network anomalies, and/or the like. According to some embodiments, the AI engine may forecast network anomalies using a forecasting model. The AI engine may compare network traffic to the forecast network anomalies to detect the one or more additional network anomalies, according to some embodiments.

As shown in block 610, the process flow 600 may include the step of generating, using the AI engine, network anomaly remediations based on the network anomalies and the one or more additional network anomalies. In some embodiments, the network anomaly remediations may comprise mitigating corrective responsive actions to remediate threats associated with the network anomalies and/or the one or more additional network anomalies. Corrective responsive actions may comprise shutting down the network gateway, restricting intra-on-premises network transmissions, partitioning at least one network into subnets for revising network traffic flow, shutting down network ports, opening additional network ports, requiring re-authenticating and re-authorizing access of a user and/or network device and/or one or more application platforms, revoking authorization, revoking access, implementing additional authorization and/or authentication requirements (e.g., multifactor authentication), and/or the like.

As shown in block 612, the process flow 600 may include the step of generating and transmitting a remediation notification, via the communication channel, comprising the network anomaly remediations. In some embodiments, the AI engine may generate and/or transmit the notification. In some embodiments, the notification may comprise transmitting network data packets, text message, email, instant message, audio transmissions, video transmissions, alert via user interface, and/or push notification to a mobile device. According to some embodiments, the communication channel may comprise end-to-end encryption, a secure socket layer, transport layer security, and/or the like. By way of non-limiting example, and in some configurations, the network anomaly remediations may be transmitted via the communication channel and displayed upon a user interface. The user interface may comprise a display comprising menus with the various network anomaly remediations. A user may select one or more network anomaly remediations utilizing input devices, a mixed reality application, buttons corresponding to network event remediations, voice communications, and/or text messages, according to some embodiments. According to some embodiments, the network anomaly remediations displayed on the user interface may comprise control buttons, wherein the control buttons (e.g., approve, reject, modify, and/or the like), upon selection, may comprise determined network event remediations.

As shown in block 614, the process flow 600 may include the step of receiving control signals from the one or more network devices, wherein the control signals comprise determined network anomaly remediations. According to some embodiments, the determined network anomaly remediations may comprise a selection of one or more network anomaly remediations that are transmitted to the one or more network devices and which the user may have selected. In some embodiments, determined network anomaly remediations may comprise a subset of the network anomaly remediations, may comprise all of the network anomaly remediations, and/or may comprise none of the network anomaly remediations. The determined network anomaly remediations may comprise a set of alternate network anomaly remediations determined by the user, one or more network devices, operator, and/or the like, according to some embodiments. In such configurations, and in some embodiments, the network anomaly remediations may be rejected and/or replaced with the alternate network anomaly remediations. The alternate network anomaly remediations may be generated (via the AI engine, system, user, and/or the like) based on a dynamic network anomaly trigger that modifies the network conditions and transmitted to a user device and/or one or more network devices for evaluation, according to some embodiments.

As shown in block 616, the process flow 600 may include the step of executing, via the AI engine, the determined network anomaly remediations. According to some embodiments, executing, using the AI engine, the determined network anomaly remediations may occur dynamically upon receipt of the control signals from the one or more network devices, upon a predetermined interval schedule via batch processing, and/or at a time defined by the system, user, and/or one or more network devices. In some embodiments, when there are at least two determined network anomaly remediations, executing the determined network anomaly remediations may occur in series or parallel. After executing the determined network anomaly remediations, the AI engine and/or system may generate and transmit an alert indicating a successful execution of the determined network anomaly remediations, wherein the alert may comprise a push notification, email, instant message, text message, and/or the like. According to some embodiments, if an error occurs during execution of the determined network anomaly remediations, the AI engine may intercept the execution, generate an error log, transmit a notification comprising the error log, and proceed with executing any remaining determined network anomaly remediations.

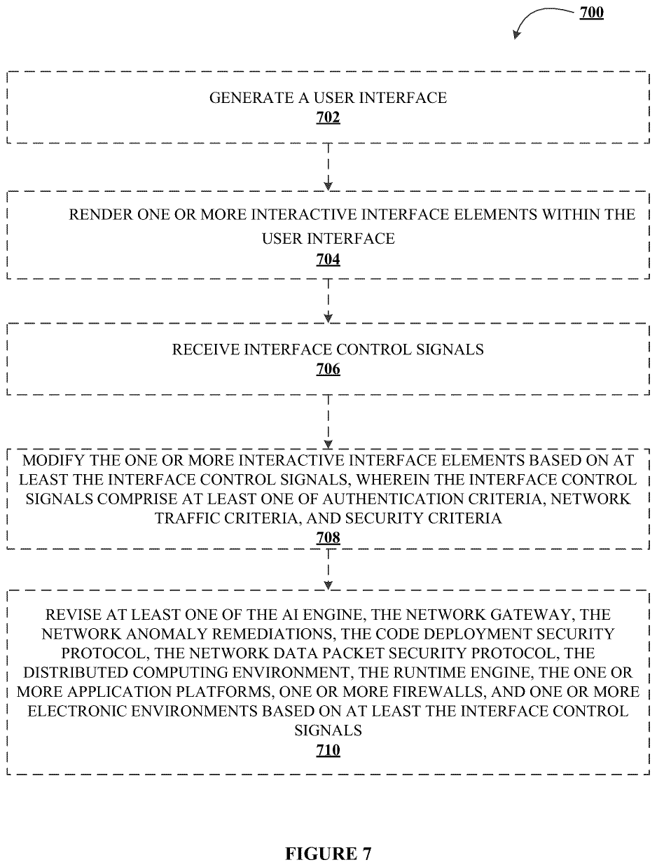

FIG. 7 illustrates a process flow 700 for modifying requirements for authentication, network traffic, and security. In some embodiments, a system (e.g., similar to one or more of the systems described herein with respect to FIGS. 1A-1C) may perform one or more of the steps of process flow 700. For example, an anomaly detection in hybrid infrastructure deployment environments system (e.g., the system 130 described herein with respect to FIGS. 1A-1C) may perform the steps of process flow 700. In some embodiments, an AI engine (e.g., such as the AI engine like that described in FIG. 2) or a generative AI subsystem (e.g., such as the generative AI subsystem described in FIG. 3) may perform some or all of the steps described in process flow 700.

As shown in block 702, the process flow 700 may include the step of generating a user interface. According to some embodiments, the user interface may be disposed within a display device, mixed reality headset, projector system, mobile device, glasses, and/or the like. The user interface may comprise input devices and output devices, including without limitation physical buttons, capacitive touch buttons, digital icons and buttons, audio transmitter, audio receiver, microphone, speaker, and/or headphones, according to some embodiments.

As shown in block 704, the process flow 700 may include the step of rendering one or more interactive interface elements within the user interface. According to some embodiments, the one or more interactive interface elements may comprise menus, channels, icons, digital buttons, dashboards, graphs associated with the network anomaly remediations, digital objects, and/or the like. The one or more interactive elements may activate upon selection, interaction, and/or input from the user, according to some embodiments.

As shown in block 706, the process flow 700 may include the step of receiving interface control signals. According to some embodiments, the interface control signals may be associated with input devices, mobile device, one or more network devices, the interactive interface elements, microphone, audio transmitter, and/or the like. By way of non-limiting example, and in some embodiments, a user may interact with the one or more interactive interface elements, which generates interface control signals. According to some embodiments, the interface control signals may be associated with API policies, authentication and authorization criteria, security criteria, and/or traffic management criteria, network anomaly remediations, determined network anomaly remediations, alternative network anomaly remediations, AI engine, the network gateway, the network anomaly remediations, the code deployment security protocol, the network data packet security protocol, the distributed computing environment, the runtime engine, the one or more application platforms, one or more firewalls, and one or more electronic environments, and/or the like.

As shown in block 708, the process flow 700 may include the step of modifying the one or more interactive interface elements based on at least the interface control signals, wherein the interface control signals comprise at least one of authentication criteria, network traffic criteria, and security criteria. In some embodiments, the interface control signals may be associated with API policies, network anomaly remediations, determined network anomaly remediations, alternative network anomaly remediations, AI engine, the network gateway, the network anomaly remediations, the code deployment security protocol, the network data packet security protocol, the distributed computing environment, the runtime engine, the one or more application platforms, one or more firewalls, and one or more electronic environments, and/or the like, according to some embodiments. By way of non-limiting example, and in some embodiments, the AI engine may generate a new rendering of the user interface comprising the modified one or more interface elements to display selections made by a user. In such configurations, the user interface may display new menus, channels, revised analytics associated with performance of the API console, runtime engine, AI engine, network gateway, gateway firewall, and/or the like.

As shown in block 710, the process flow may include the step of revising at least one of the AI engine, the network gateway, the network anomaly remediations, the code deployment security protocol, the network data packet security protocol, the distributed computing environment, the runtime engine, the one or more application platforms, one or more firewalls, and one or more electronic environments based on at least the interface control signals. In some embodiments, the AI engine may dynamically determine how to execute the revisions based on the interface control signals. In some embodiments, the interface control signals may specify to the AI engine and/or system how to execute the revisions (e.g., update the trusted IP address list, require additional authentication, and/or the like). If an error is encountered during execution, the AI engine and/or system may intercept the revisions and generate an alert comprising an error log, according to some embodiments. Upon successful revisions execution, the AI engine and/or system may transmit a success message to the user and/or one or more network devices.

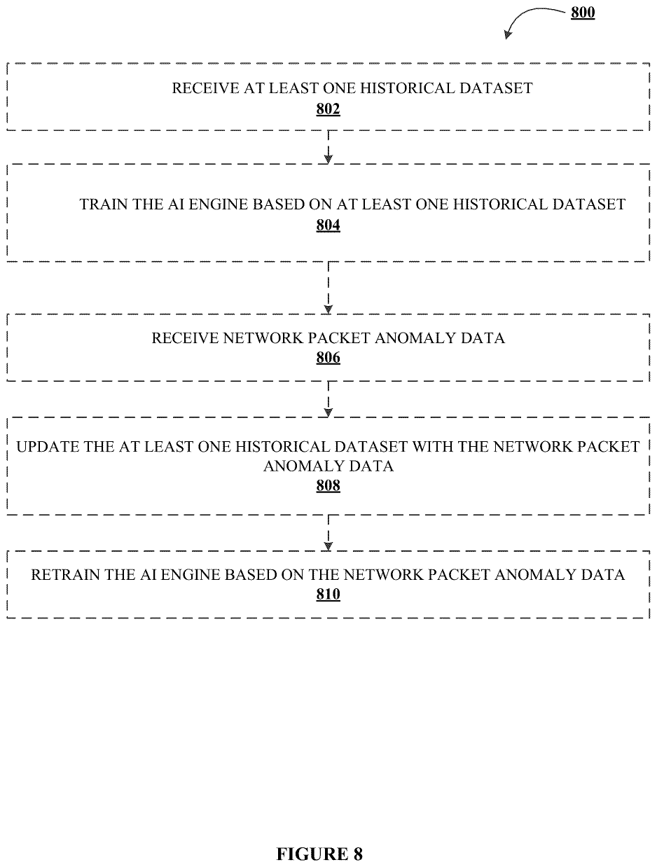

FIG. 8 illustrates a process flow 800 for training and retraining the AI engine, in accordance with an embodiment of the disclosure. In some embodiments, a system (e.g., similar to one or more of the systems described herein with respect to FIGS. 1A-1C) may perform one or more of the steps of process flow 800. For example, an anomaly detection in hybrid infrastructure deployment environments system (e.g., the system 130 described herein with respect to FIGS. 1A-1C) may perform the steps of process flow 800. In some embodiments, an AI engine (e.g., such as the AI engine like that described in FIG. 2) or a generative AI subsystem (e.g., such as the generative AI subsystem described in FIG. 3) may perform some or all of the steps described in process flow 800.

As shown in block 802, the process flow 800 may include the step of receiving at least one historical dataset. The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the AI engine may be trained. In some embodiments, the system may receive the at least one historical dataset continuously, at set internals, and/or via on-demand request generated by the AI engine, a user, an AI engine training controller, network device, and/or the like. In some embodiments, the system may receive the entire at least one historical dataset. According to sone embodiments, the system may only receive a subset of data contained within the at least one historical dataset based on training requirements associated with an AI engine training request generated by the system, user, network device, and/or the like. By training the AI engine on only a subset of the at least one historical dataset based on the most material and/or relevant data, the system may conserve computing resources, minimize energy expenditures, and/or enhance the AI engine performance. In some embodiments, the subset of data may not comprise sensitive data, preventing the inclusion of sensitive data in training the AI engine, which enhances data security and privacy.

As shown in block 804, the process flow 800 may include the step of training the AI engine based on the at least one historical dataset. In some embodiments, the at least one historical dataset comprises historical code deployment metadata, historical code deployment security protocols, historical network data packets, historical network anomalies, historical notifications, historical threat remediation protocols, historical network data packet security protocols, historical code packages, historical network traffic data, historical one or more additional network anomalies, historical network anomaly remediations, historical determined network anomaly remediations, historical alternate network anomaly remediations, historical network packet anomaly data, historical API policies, historical authentication criteria, historical network traffic criteria, and/or historical security criteria. In some embodiments the AI engine may comprise a generative AI model, in which training the generative AI model may comprise ingesting the historical dataset, adjusting parameters in response to generative AI model output, evaluating the model for fine-tuning, and/or deploying the generative AI model.

As shown in block 806, the process flow 800 may include the step of receiving network packet anomaly data. In some embodiments, receiving the network packet anomaly data may comprise receiving network data packets comprising the network packet anomaly data. In some embodiments, a data aggregator may collect network packet anomaly data to generate aggregated network packet anomaly data and transmit the aggregated network packet anomaly data via network data packets to the system and/or AI engine. In some embodiments, the data aggregator may pre-process the network packet anomaly data, such as data cleansing, encrypting, and/or executing an ETL process. In some embodiments, the system may process the received network data packets, such as executing decryption, data extraction, and/or the like.

As shown in block 808, the process flow 800 may include the step of updating the at least one historical dataset with the network packet anomaly data. In some embodiments, the network packet anomaly data may be attached to the at least one historical dataset. In such a configuration, an ETL process may be executed to transmit the network packet anomaly data dataset to the same data storage repository as the at least one historical dataset.

As shown in block 810, the process flow 800 may include the step of retraining the AI engine based on the network packet anomaly data. The retraining step may be executed via feedback loop for continuous retraining and/or the retraining may occur via internal-based batch jobs, according to some embodiments. In some embodiments, the AI engine may refine itself by revising its weights and other such decision factors to improve accuracy, speed, and minimize errors, based on AI engine training confidence threshold. In some embodiments, the system may determine the AI engine training confidence threshold, and if the AI engine training confidence threshold is below a given confidence threshold (e.g., predetermined, determined via notification from a network device, and/or dynamically determined by the system), the system may trigger retraining of the AI engine. In some embodiments, if criteria (e.g., API policies, authentication criteria, security criteria, network traffic criteria, user requests, and/or the like) and/or network packet anomaly data are generated and/or received by the system and/or AI engine (hereinafter referred to as “new training factors”), then the system and/or AI engine may trigger in real-time retraining of the AI engine based on the new training factors. By constantly monitoring for new training factors and triggering a responsive real-time retraining, the system provides a technical solution to the challenge of monitoring new training factors and changing network traffic conditions and adjusting the system dynamically.

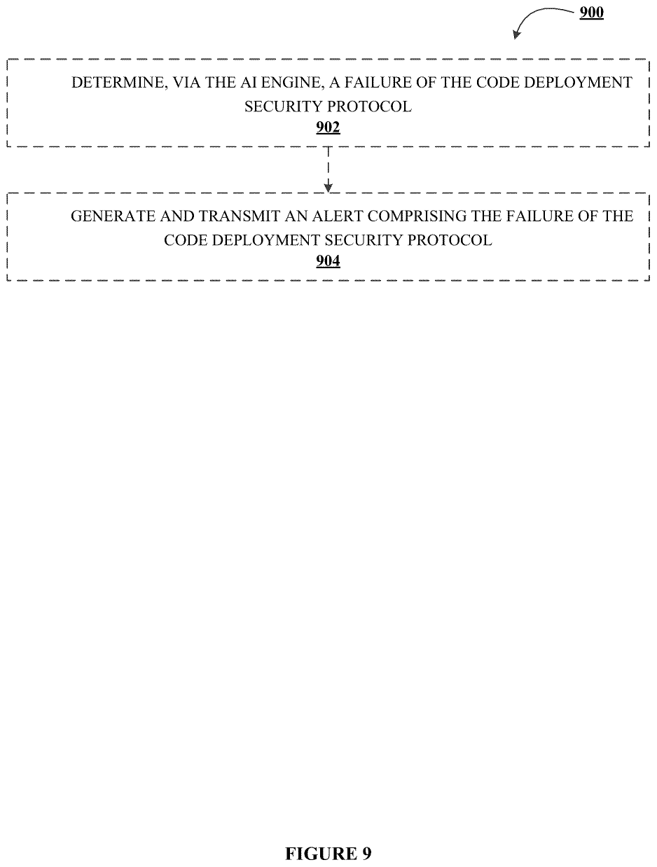

FIG. 9 illustrates a process flow 900 for generating an alert based on the code deployment security protocol, in accordance with an embodiment of the disclosure. In some embodiments, a system (e.g., similar to one or more of the systems described herein with respect to FIGS. 1A-1C) may perform one or more of the steps of process flow 900. For example, an anomaly detection in hybrid infrastructure deployment environments system (e.g., the system 130 described herein with respect to FIGS. 1A-1C) may perform the steps of process flow 900. In some embodiments, an AI engine (e.g., such as the AI engine like that described in FIG. 2) or a generative AI subsystem (e.g., such as the generative AI subsystem described in FIG. 3) may perform some or all of the steps described in process flow 900.

As shown in block 902, the process flow 900 may include the step of determining, via the AI engine, a failure of the code deployment security protocol. In some embodiments, the code deployment security protocol may fail due to a failure of the code signing the code deployment metadata and/or the encrypting the code deployment metadata. When the code deployment security protocol fails, the AI engine may generate an error log, wherein the error log details a timestamp, cause for the failure, description of the failure, identifying data associated with the code deployment metadata, and/or the like, in some embodiments. According to some embodiments, the AI engine may flag, lock, and/or isolate the private key associated with the failure of the code deployment security protocol.

As shown in block 904, the process flow 900 may include the step of generating and transmitting an alert comprising the failure of the code deployment security protocol. In some embodiments, the AI engine may generate and/or transmit the alert. The alert may comprise a push notification, email, instant message, text message, and/or the like, in accordance with some embodiments. In some embodiments, the alert may comprise the error log.

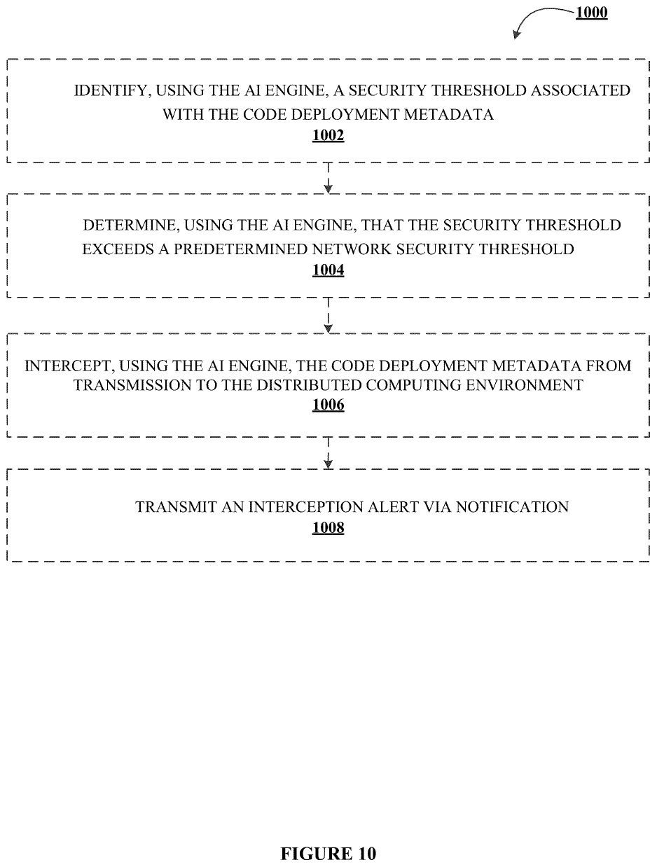

FIG. 10 illustrates a process flow 1000 for intercepting, using the AI engine, the code deployment metadata from transmission, in accordance with an embodiment of the disclosure. In some embodiments, a system (e.g., similar to one or more of the systems described herein with respect to FIGS. 1A-1C) may perform one or more of the steps of process flow 1000. For example, an anomaly detection in hybrid infrastructure deployment environments system (e.g., the system 130 described herein with respect to FIGS. 1A-1C) may perform the steps of process flow 1000. In some embodiments, an AI engine (e.g., such as the AI engine like that described in FIG. 2) or a generative AI subsystem (e.g., such as the generative AI subsystem described in FIG. 3) may perform some or all of the steps described in process flow 1000.

As shown in block 1002, the process flow 1000 may include the step of identifying, using the AI engine, a security threshold associated with the code deployment metadata. In some embodiments, the security threshold may comprise security criteria associated with confidential, personally identifying, and/or sensitive data. The security threshold may indicate whether the type and content of the data contained in the code deployment metadata is ineligible for hosting outside the on-premises environment, in some embodiments. According to some embodiments, the security threshold may comprise a qualitative descriptor, quantitative value, and/or the like, in some embodiments. In some embodiments, the qualitative descriptor may comprise a letter grade (e.g., A to F), a written description (e.g., high, medium, low, and/or the like), and/or the like. In some embodiments, the quantitative value may comprise a numerical rating (e.g., whole number, decimals, and/or the like) on a spectrum (e.g., from zero to one hundred), wherein smaller numerical ratings may be associated with lower security thresholds and higher numerical ratings may be associated with higher security thresholds.

As shown in block 1004, the process flow 1000 may include the step of determining, using the AI engine, that the security threshold exceeds a predetermined network security threshold. In some embodiments, the predetermined network security threshold may be determined by the AI engine dynamically in real-time, via batch processing, and/or via on-demand request. According to some embodiments, the predetermined network security threshold may comprise a qualitative descriptor, quantitative value, and/or the like, in some embodiments. In some embodiments, the qualitative descriptor may comprise a letter grade (e.g., A to F), a written description (e.g., high, medium, low, and/or the like), and/or the like. In some embodiments, the quantitative value may comprise a numerical rating (e.g., whole number, decimals, and/or the like) on a spectrum (e.g., from zero to one hundred), wherein smaller numerical ratings may be associated with lower predetermined network security thresholds and higher numerical ratings may be associated with higher predetermined network security thresholds. According to some embodiments, determining that the security threshold exceeds a predetermined network security threshold may occur real-time, via batch processing, and/or via on-demand request. In some embodiments, the AI engine may determine that the security threshold is less than or equal to the predetermined network security threshold. In such configurations, and in some embodiments, the system may not initiate an interception protocol to prevent the code deployment metadata from transmitting to the distributed computing environment.

As shown in block 1006, the process flow 1000 may include the step of intercepting, using the AI engine, the code deployment metadata from transmission to the distributed computing environment. According to some embodiments, intercepting the code deployment metadata comprises blocking transmission to the distributed computing environment via gateway firewall denial. In some embodiments, intercepting may comprise generating an interception log, which may comprise logic for the interception, timestamp, infrastructure identification metadata, code deployment metadata, data associated with the code deployment metadata, the security threshold, the predetermined security threshold, analytics associated with the interception, and/or the like. In some embodiments, the AI engine may determine whether to intercept additional code deployment metadata transmissions based upon intercepting the code deployment metadata.

As shown in block 1008, the process flow 1000 may include the step of transmitting an interception alert via notification. The interception alert may comprise a push notification, email, instant message, text message, and/or the like, in accordance with some embodiments. According to some embodiments, the AI engine may generate and transmit the interception alert. The interception alert may comprise the recommendations associated with remediating anomalies associated with the interception, interception log, code deployment metadata, data associated with the code deployment metadata, the security threshold, the predetermined security threshold, analytics associated with the interception, and/or the like.

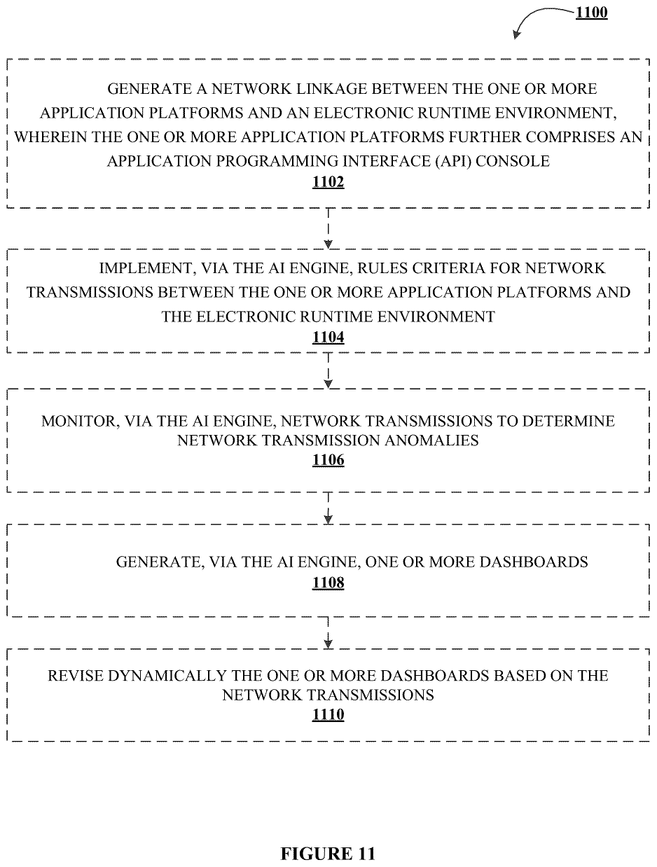

FIG. 11 illustrates a process flow 1100 for generating, via the AI engine, and revising one or more dashboards, in accordance with an embodiment of the disclosure. In some embodiments, a system (e.g., similar to one or more of the systems described herein with respect to FIGS. 1A-1C) may perform one or more of the steps of process flow 1100. For example, an anomaly detection in hybrid infrastructure deployment environments system (e.g., the system 130 described herein with respect to FIGS. 1A-1C) may perform the steps of process flow 1100. In some embodiments, an AI engine (e.g., such as the AI engine like that described in FIG. 2) or a generative AI subsystem (e.g., such as the generative AI subsystem described in FIG. 3) may perform some or all of the steps described in process flow 1100.

As shown in block 1102, the process flow 1100 may include the step of generating a network linkage between the one or more application platforms and an electronic runtime environment, wherein the one or more application platforms further comprises an application programming interface (API) console. In some embodiments, initiating the network linkage may comprise a two-way network request transmitted between the one or more application platforms and the electronic runtime environment, authenticating at least one of the one or more application platforms and the electronic runtime environment, and/or transmitting a test message to confirm the success of the initiation, according to some embodiments. According to some embodiments, the network linkage may comprise a communication pathway, a secure socket layer, transport layer security, and/or the like. In some embodiments, the API console may comprise an API management console for the design, development, testing, and maintenance of APIs. According to some embodiments, the API console may comprise an API repository, including with limitation version history, release cycle dates, specifications, testing history, documentation associated with each API, historical API requests, and/or historical API responses. According to some embodiments, the network linkage between the one or more application platforms and an electronic runtime environment may provide the exchange of analytics, logging, monitoring, and/or application management functionality.

As shown in block 1104, the process flow 1100 may include the step of implementing, via the AI engine, rules criteria for network transmissions between the one or more application platforms and the electronic runtime environment. In some embodiments, the rules criteria may comprise traffic management criteria, including without limitation throttling (e.g., control network traffic flow between on-premises and cloud electronic environments), IP address restrictions (e.g., validating that only trusted IP addresses are allowed to interact with on-premises systems), and/or rate limiting (e.g., restricting the quantity of API requests from at least one determined IP address and/or application to prevent network overload). In some embodiments, the rules criteria may comprise open authorization, JWT, SAML, and/or authorization criteria to control access between the one or more application platforms and the electronic runtime environment. In some embodiments, the rules criteria may comprise evaluating digital signatures using heuristic analysis, SQL injection prevention criteria, and/or traffic monitoring criteria to prevent DDoS attacks.

As shown in block 1106, the process flow 1100 may include the step of monitoring, via the AI engine, network transmissions to determine network transmission anomalies. The AI engine may analyze the network transmissions to determine abnormal patterns in cloud-to-on-premises network transmissions (e.g., one-way and/or two way network transmissions), according to some embodiments. In some embodiments, the AI engine may detect network transmission anomalies associated with abnormal traffic patterns (e.g., spikes from specific IP addresses, the one or more application platforms, and/or the like) associated with malicious attacks and/or unauthorized access attempts. In some embodiments, the AI engine may comprise a machine learning algorithm to learn regular traffic behavior over time periods. By way of non-limiting example, and in some embodiments, the AI engine may detect deviations in traffic behavior, execute behavioral analyses, and determine deviations in traffic behavior that signal an intrusion by an unauthorized actor and/or a misconfiguration in infrastructure, software, software services, and/or the like (e.g., network transmission anomalies).

As shown in block 1108, the process flow 1100 may include the step of generating, via the AI engine, one or more dashboards. In some embodiments, the one or more dashboards may comprise analytics associated with code deployment metadata, code packages, artifacts, APIs, network transmissions, runtime engine performance, network transmission anomalies, rules criteria, network anomalies, network anomaly remediations, determined network anomaly remediations, logs, and/or alerts. According to some embodiments, the one or more dashboards may comprise automated reports associated with network anomalies, network transmissions anomalies, and/or the like. In some embodiments, the one or more dashboards may comprise pre-built API policies, dashboards, and/or analytics tools to track API health, performance, and security

As shown in block 1110, the process flow 1100 may include the step of revising dynamically the one or more dashboards based on the network transmissions. According to some embodiments, the system and/or AI engine may revise the one or more dashboards dynamically in real-time based on the network transmissions. In some embodiments, the one or more dashboards may be revised based on real-time network traffic, code deployment metadata, code packages, artifacts, APIs, network transmissions, runtime engine performance, network transmission anomalies, rules criteria, network anomalies, network anomaly remediations, determined network anomaly remediations, logs, and/or alerts. In some embodiments, the one or more dashboards may be revised via batch processing at set intervals and/or via on-demand request.

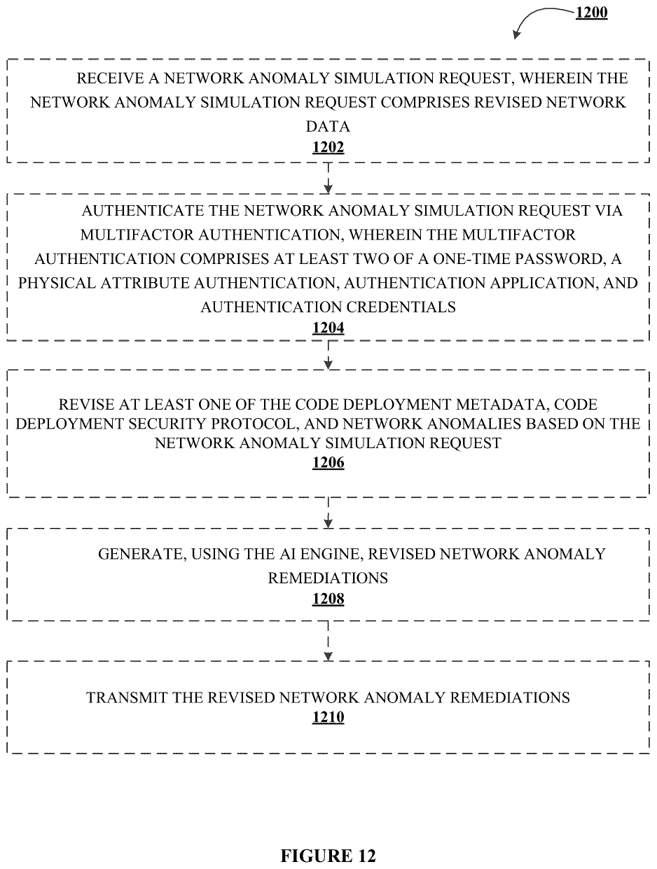

FIG. 12 illustrates a process flow 1200 for generating revised network anomaly remediations, in accordance with an embodiment of the disclosure. In some embodiments, a system (e.g., similar to one or more of the systems described herein with respect to FIGS. 1A-1C) may perform one or more of the steps of process flow 1200. For example, an anomaly detection in hybrid infrastructure deployment environments system (e.g., the system 130 described herein with respect to FIGS. 1A-1C) may perform the steps of process flow 1200. In some embodiments, an AI engine (e.g., such as the AI engine like that described in FIG. 2) or a generative AI subsystem (e.g., such as the generative AI subsystem described in FIG. 3) may perform some or all of the steps described in process flow 1200.

As shown in block 1202, the process flow 1200 may include the step of receiving a network anomaly simulation request, wherein the network anomaly simulation request comprises revised network data. In some embodiments, the revised network data may comprise revisions to the network traffic data, code deployment metadata, code packages, artifacts, APIs, network transmissions, runtime engine criteria, network transmission anomalies, rules criteria, network anomalies, network anomaly remediations, determined network anomaly remediations, logs, and/or alerts. According to some embodiments, the network simulation request may comprise simulating network anomalies and/or network anomaly remediations, updating the API policies, and/or the like.

As shown in block 1204, the process flow 1200 may include the step of authenticating the network anomaly simulation request via multifactor authentication, wherein the multifactor authentication comprises at least two of a one-time password, a physical attribute authentication, authentication application, and authentication credentials. In some embodiments, the network anomaly simulation request may comprise the authentication methods required for the multifactor authentication. According to some embodiments, the multifactor authentication may be determined by the AI engine based on at least data security requirements, network access controls, network anomalies, network transmission anomalies, known threats, privacy requirements, geographic regulatory requirements, and/or the like. In some embodiments, the network anomaly simulation request may comprise an encrypted message which may require decryption via the AI engine to access and read the request.

As shown in block 1206, the process flow 1200 may include the step of revising at least one of the code deployment metadata, code deployment security protocol, and network anomalies based on the network anomaly simulation request. The AI engine may execute such revisions to the code deployment metadata, code deployment security protocol, and network anomalies, and/or the like, dynamically, on-demand, or via internal batch processing, according to some embodiments. According to some embodiments, the AI engine may execute revisions based on the network anomaly request by updating associated values within an internal data repository.

As shown in block 1208, the process flow 1200 may include the step of generating, using the AI engine, revised network anomaly remediations. The revised network anomaly remediations may comprise updated determined network anomaly remediations, alternate network anomaly remediations, network transmission anomalies, network transmission anomaly remediations, network anomalies, and/or the like. According to some embodiments of the disclosure, the AI engine may trigger and execute a network anomaly remediation protocol based on at least the revised network anomaly remediations.

As shown in block 1210, the process flow 1200 may include the step of transmitting the revised network anomaly remediations. In some embodiments, transmitting the revised network anomaly remediations comprises an alert, wherein the alert comprises a description of the revised network anomaly remediations, analytics associated with network anomaly remediation, and/or the like. In some embodiments, the alert may comprise an email, text message, push-notification, alert, dashboard alert, and/or the like. In some embodiments, the alert may require authentication (e.g., multi-factor authentication, one-time password, physical attribute authentication, authenticator mobile application, PIN code, and/or the like) to access and read the alert. In some embodiments, the alert may comprise an encrypted message which may require a decrypting program to access and read the alert.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for anomaly detection in hybrid infrastructure deployment environments, the system comprising:
a memory device with computer-readable program code stored thereon;
at least one processing device, wherein executing the computer-readable program code is configured to cause the at least one processing device to execute the computer-readable program code to:
receive and extract code deployment metadata from one or more code repositories;
execute a code deployment security protocol on the code deployment metadata;
transmit the code deployment metadata to a distributed computing environment, wherein the distributed computing environment comprises one or more application platforms;
receive network data packets from the one or more application platforms via a network gateway;
determine, using an AI engine, network anomalies based on the network data packets; and
generate and transmit a notification based on the network anomalies.

2. The system of claim 1, wherein executing the computer-readable program code is further configured to cause the at least one processing device to:
segment, via the AI engine, the network anomalies for a threat remediation protocol;
execute a network data packet security protocol on the network data packets, wherein the network data packet security protocol comprises decrypting the network data packets and validating code signing of the network data packets;
transmit the network data packets to a runtime engine; and
execute, via the runtime engine, a code package based on at least the network data packets.

3. The system of claim 2, wherein executing the computer-readable program code is further configured to cause the at least one processing device to:
generate, using the AI engine, a communication channel to one or more network devices, wherein the AI engine comprises a generative AI model;
authenticate the one or more network devices;
monitor, via the AI engine, network traffic data based on one or more internal networks;
identify, via the AI engine, one or more additional network anomalies based on at least the network traffic data;
generate, using the AI engine, network anomaly remediations based on the network anomalies and the one or more additional network anomalies;
generate and transmit a remediation notification, via the communication channel, comprising the network anomaly remediations;
receive control signals from the one or more network devices, wherein the control signals comprise determined network anomaly remediations; and
execute, via the AI engine, the determined network anomaly remediations.

4. The system of claim 3, wherein executing the computer-readable program code is further configured to cause the at least one processing device to:
generate a user interface;
render one or more interactive interface elements within the user interface;
receive interface control signals;
modify the one or more interactive interface elements based on at least the interface control signals, wherein the interface control signals comprise at least one of authentication criteria, network traffic criteria, and security criteria; and
revise at least one of the AI engine, the network gateway, the network anomaly remediations, the code deployment security protocol, the network data packet security protocol, the distributed computing environment, the runtime engine, the one or more application platforms, one or more firewalls, and one or more electronic environments based on at least the interface control signals.

5. The system of claim 1, wherein the code deployment security protocol further comprises code signing the code deployment metadata and encrypting the code deployment metadata.

6. The system of claim 1, wherein executing the computer-readable program code is further configured to cause the at least one processing device to:
receive at least one historical dataset;
train the AI engine based on the at least one historical dataset;
receive network packet anomaly data;
update the at least one historical dataset with the network packet anomaly data; and
retrain the AI engine based on the network packet anomaly data.

7. The system of claim 1, wherein executing the computer-readable program code is further configured to cause the at least one processing device to:
determine, via the AI engine, a failure of the code deployment security protocol; and
generate and transmit an alert comprising the failure of the code deployment security protocol.

8. The system of claim 1, wherein executing the computer-readable program code is further configured to cause the at least one processing device to:
identify, using the AI engine, a security threshold associated with the code deployment metadata;
determine, using the AI engine, that the security threshold exceeds a predetermined network security threshold;
intercept, using the AI engine, the code deployment metadata from transmission to the distributed computing environment; and
transmit an interception alert via notification.

9. The system of claim 1, wherein executing the computer-readable program code is further configured to cause the at least one processing device to:
generate a network linkage between the one or more application platforms and an
electronic runtime environment, wherein the one or more application platforms further comprises an application programming interface (API) console;
implement, via the AI engine, rules criteria for network transmissions between the one or more application platforms and the electronic runtime environment;
monitor, via the AI engine, network transmissions to determine network transmission anomalies;
generate, via the AI engine, one or more dashboards; and
revise dynamically the one or more dashboards based on the network transmissions.

10. The system of claim 1, wherein executing the computer-readable program code is further configured to cause the at least one processing device to:
receive a network anomaly simulation request, wherein the network anomaly simulation request comprises revised network data;
authenticate the network anomaly simulation request via multifactor authentication, wherein the multifactor authentication comprises at least two of a one-time password, a physical attribute authentication, authentication application, and authentication credentials;
revise at least one of the code deployment metadata, code deployment security protocol, and network anomalies based on the network anomaly simulation request;
generate, using the AI engine, revised network anomaly remediations; and
transmit the revised network anomaly remediations.

11. A computer program product for anomaly detection in hybrid infrastructure deployment environments, wherein the computer program product comprises at least one non-transitory computer-readable medium having computer-readable program code portion embodied therein, the computer-readable program code portions which when executed by a processing device are configured to cause a processor to:
receive and extract code deployment metadata from one or more code repositories;
execute a code deployment security protocol on the code deployment metadata;
transmit the code deployment metadata to a distributed computing environment, wherein the distributed computing environment comprises one or more application platforms;
receive network data packets from the one or more application platforms via a network gateway;
determine, using an AI engine, network anomalies based on the network data packets; and
generate and transmit a notification based on the network anomalies.

12. The computer program product of claim 11, wherein the processing device is further configured to:
segment, via the AI engine, the network anomalies for a threat remediation protocol;
execute a network data packet security protocol on the network data packets, wherein the network data packet security protocol comprises decrypting the network data packets and validating code signing of the network data packets;
transmit the network data packets to a runtime engine; and
execute, via the runtime engine, a code package based on at least the network data packets.

13. The computer program product of claim 12, wherein the processing device is further configured to:
generate, using the AI engine, a communication channel to one or more network devices, wherein the AI engine comprises a generative AI model;
authenticate the one or more network devices;
monitor, via the AI engine, network traffic data based on one or more internal networks;
identify, via the AI engine, one or more additional network anomalies based on at least the network traffic data;
generate, using the AI engine, network anomaly remediations based on the network anomalies and the one or more additional network anomalies;
generate and transmit a remediation notification, via the communication channel, comprising the network anomaly remediations;
receive control signals from the one or more network devices, wherein the control signals comprise determined network anomaly remediations; and
execute, via the AI engine, the determined network anomaly remediations.

14. The computer program product of claim 13, wherein the processing device is further configured to:
generate a user interface;
render one or more interactive interface elements within the user interface;
receive interface control signals;
modify the one or more interactive interface elements based on at least the interface control signals, wherein the interface control signals comprise at least one of authentication criteria, network traffic criteria, and security criteria; and
revise at least one of the AI engine, the network gateway, the network anomaly remediations, the code deployment security protocol, the network data packet security protocol, the distributed computing environment, the runtime engine, the one or more application platforms, one or more firewalls, and one or more electronic environments based on at least the interface control signals.

15. The computer program product of claim 11, wherein the code deployment security protocol further comprises code signing the code deployment metadata and encrypting the code deployment metadata.

16. The computer program product of claim 11, wherein the processing device is further configured to:
receive at least one historical dataset;
train the AI engine based on the at least one historical dataset;
receive network packet anomaly data;
update the at least one historical dataset with the network packet anomaly data; and
retrain the AI engine based on the network packet anomaly data.

17. The computer program product of claim 11, wherein the processing device is further configured to:
determine, via the AI engine, a failure of the code deployment security protocol; and
generate and transmit an alert comprising the failure of the code deployment security protocol.

18. A computer-implemented method for anomaly detection in hybrid infrastructure deployment environments:
receiving and extracting code deployment metadata from one or more code repositories;
executing a code deployment security protocol on the code deployment metadata;
transmitting the code deployment metadata to a distributed computing environment, wherein the distributed computing environment comprises one or more application platforms;
receiving network data packets from the one or more application platforms via a network gateway;
determining, using an AI engine, network anomalies based on the network data packets; and
generating and transmitting a notification based on the network anomalies.

19. The computer-implemented method of claim 18, wherein the computer-implemented method is further configured for:
segmenting, via the AI engine, the network anomalies for a threat remediation protocol;
executing a network data packet security protocol on the network data packets, wherein the network data packet security protocol comprises decrypting the network data packets and validating code signing of the network data packets;
transmitting the network data packets to a runtime engine; and
executing, via the runtime engine, a code package based on at least the network data packets.

20. The computer-implemented method of claim 19, wherein the computer-implemented method is further configured for:
generating, using the AI engine, a communication channel to one or more network devices, wherein the AI engine comprises a generative AI model;
authenticate the one or more network devices;
monitor, via the AI engine, network traffic data based on one or more internal networks;
identifying, via the AI engine, one or more additional network anomalies based on at least the network traffic data;
generating, using the AI engine, network anomaly remediations based on the network anomalies and the one or more additional network anomalies;
generating and transmitting a remediation notification, via the communication channel, comprising the network anomaly remediations;
receiving control signals from the one or more network devices, wherein the control signals comprise determined network anomaly remediations; and
executing, via the AI engine, the determined network anomaly remediations.
